(19) United States
(12) Patent Application Publication
(10) Pub. No.: US 2017/0124375 A1
(43) Pub. Date: May 4, 2017

(54) FINGERPRINT IMAGE CAPTURING DEVICE AND FINGERPRINT IMAGE CAPTURING MODULE THEREOF

(71) Applicant: PACING TECHNOLOGY CO., LTD., Taipei City (TW)

(72) Inventor: CHI-WANG TSENG, TAIPEI CITY (TW)

(21) Appl. No.: 15/073,712

(22) Filed: Mar. 18, 2016

(30) Foreign Application Priority Data
Oct. 30, 2015 (TW) 104135754

(51) Int. Cl. G06K 9/00; H04N 5/225

(52) U.S. Cl. CPC G06K 9/00013; H04N 5/2256

(57) ABSTRACT

A fingerprint image capturing module includes a light-emitting element, a first optical element having two light-reflecting structures and a light-guiding structure, a second optical element, a lens assembly, and a fingerprint image sensing element. A projection light beam generated by the light-emitting element is projected onto the light-reflecting structure, the projection light beam is reflected by the light-reflecting structure to form an illumination light beam that passes through a light-transmitting element and is projected onto a fingerprint. The illumination light beam is reflected by the finger to form an image light beam that is projected onto the light-guiding structure and guided by the light-guiding structure, the image light beam passes through the lens assembly and is projected onto the fingerprint image sensing element through the second optical element, and the fingerprint image sensing element receives the image light beam to obtain a fingerprint image of the fingerprint.

### BACKGROUND OF THE INVENTION

1. Field of the Invention

The instant disclosure relates to an image capturing device and an image capturing module thereof, and more particularly to a miniaturized fingerprint image capturing device and a miniaturized fingerprint image capturing module thereof.

2. Description of Related Art

In general, the fingerprint recognition apparatus reads information about people's fingerprints by scanning their fingerprints on the apparatus. For example, when the finger touches a fingerprint touch plate, several light sources emit light for the lens to capture the fingerprint image. Because the angles between the lens and fingers, and the angles between the light source and fingers have to be adjusted to specific angles for achieving total reflection so that the fingerprint recognition apparatus can capture a clear and distinct fingerprint. Therefore, the optical fingerprint recognition apparatus in the prior art are large in size and cannot be miniaturized.

### SUMMARY OF THE INVENTION

One aspect of the instant disclosure relates to a miniaturized fingerprint image capturing device and a miniaturized fingerprint image capturing module thereof.

One of the embodiments of the instant disclosure provides a fingerprint image capturing device, comprising: a circuit substrate, an external casing, a light-transmitting element, and a fingerprint image capturing module. The external casing is disposed on the circuit substrate, and the external casing has a top opening formed on the top side thereof. The light-transmitting element is disposed on the external casing to enclose the top opening of the external casing. The fingerprint image capturing module is disposed inside the external casing, and the fingerprint image capturing module includes at least one light-emitting element, a first optical element, a second optical element, a lens assembly, and a fingerprint image sensing element. The at least one light-emitting element is electrically connected to the circuit substrate. The first optical element is disposed beside one side of the at least one light-emitting element and separated from the at least one light-emitting element by a first predetermined distance, and the first optical element has two light-reflecting structures and a light-guiding structure connected between the two light-reflecting structures. The second optical element is disposed beside another side of the at least one light-emitting element and separated from the at least one light-emitting element by a second predetermined distance. The lens assembly is disposed between the at least one light-emitting element and the second optical element. The fingerprint image sensing element is disposed under the second optical element and electrically connected to the circuit substrate. Whereby, a projection light beam generated by the at least one light-emitting element is directly projected onto the two light-reflecting structures, the projection light beam is reflected by the two light-reflecting structures to form an illumination light beam that first passes through the light-transmitting element and then is projected onto a fingerprint of a finger. The illumination light beam is reflected by the finger to form an image light beam that is projected onto the light-guiding structure and then is guided by the light-guiding structure, the image light beam first passes through the lens assembly and then is projected onto the fingerprint image sensing element through the second optical element, and the fingerprint image sensing element receives the image light beam to obtain a fingerprint image of the fingerprint of the finger.

Another one of the embodiments of the instant disclosure provides a fingerprint image capturing module, comprising: at least one light-emitting element, a first optical element, a second optical element, a lens assembly, and a fingerprint image sensing element. The first optical element is disposed beside one side of the at least one light-emitting element and separated from the at least one light-emitting element by a first predetermined distance, and the first optical element has two light-reflecting structures and a light-guiding structure connected between the two light-reflecting structures. The second optical element is disposed beside another side of the at least one light-emitting element and separated from the at least one light-emitting element by a second predetermined distance. The lens assembly is disposed between the at least one light-emitting element and the second optical element. The fingerprint image sensing element is disposed under the second optical element. Whereby, a projection light beam generated by the at least one light-emitting element is directly projected onto the two light-reflecting structures, the projection light beam is reflected by the two light-reflecting structures to form an illumination light beam that first passes through a light-transmitting element and then is projected onto a fingerprint of a finger. The illumination light beam is reflected by the finger to form an image light beam that is projected onto the light-guiding structure and then is guided by the light-guiding structure, the image light beam first passes through the lens assembly and then is projected onto the fingerprint image sensing element through the second optical element, and the fingerprint image sensing element receives the image light beam to obtain a fingerprint image of the fingerprint of the finger.

Yet another one of the embodiments of the instant disclosure provides a fingerprint image capturing module comprising at least one light-emitting element, a first optical element having two light-reflecting structures and a light-guiding structure, a second optical element, a lens assembly, and a fingerprint image sensing element, characterized in that: a projection light beam generated by the at least one light-emitting element is directly projected onto the two light-reflecting structures, the projection light beam is reflected by the two light-reflecting structures to form an illumination light beam that first passes through a light-transmitting element and then is projected onto a fingerprint of a finger. The illumination light beam is reflected by the finger to form an image light beam that is projected onto the light-guiding structure and then is guided by the light-guiding structure, the image light beam first passes through the lens assembly and then is projected onto the fingerprint image sensing element through the second optical element, and the fingerprint image sensing element receives the image light beam to obtain a fingerprint image of the fingerprint of the finger.

Therefore, the fingerprint image capturing device and the fingerprint image capturing module can be miniaturized due to the arrangement of the at least one light-emitting element, the first optical element, the second optical element, the lens assembly and the fingerprint image sensing element, thus the fingerprint image capturing device and the miniaturized fingerprint image capturing module can be applied to any miniaturization electronic product.

To further understand the techniques, means and effects of the instant disclosure applied for achieving the prescribed objectives, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows one perspective, schematic view of the fingerprint image capturing device according to the first embodiment of the instant disclosure;

FIG. 2 shows a cross-sectional view taken along the section line A-A of FIG. 1;

FIG. 3 shows a cross-sectional view taken along the section line B-B of FIG. 1;

FIG. 4 shows a top, cross-sectional, schematic view of the fingerprint image capturing device according to the second embodiment of the instant disclosure; and

FIG. 5 shows a lateral, cross-sectional, schematic view of the fingerprint image capturing device according to the second embodiment of the instant disclosure.

### DETAILED DESCRIPTION OF THE PREFERRED EMBODIMENTS

The embodiments of “a fingerprint image capturing device and a fingerprint image capturing module thereof” of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

### First Embodiment

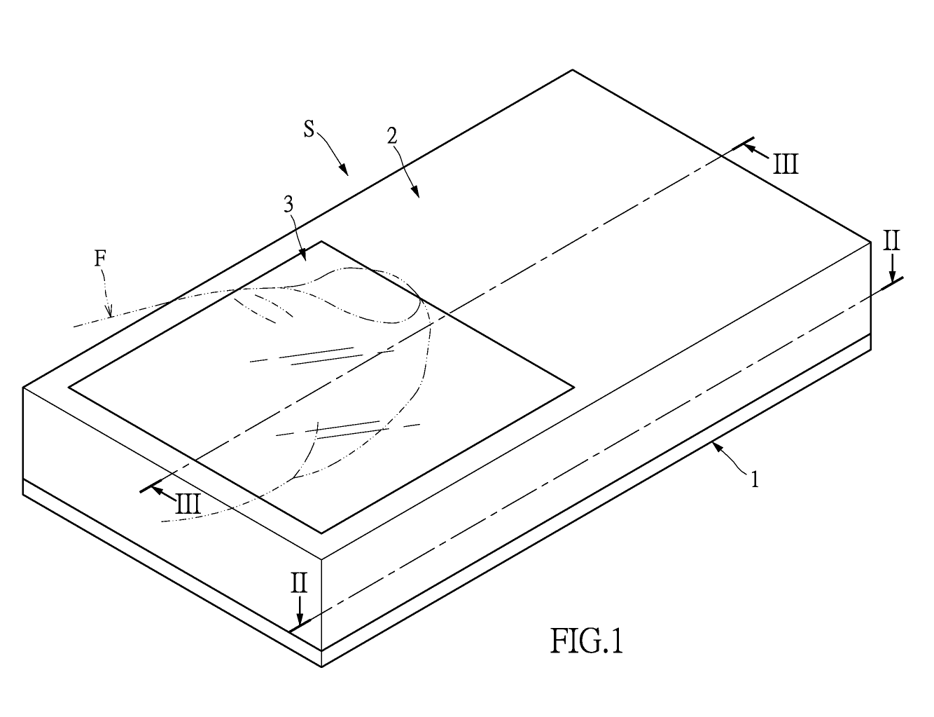

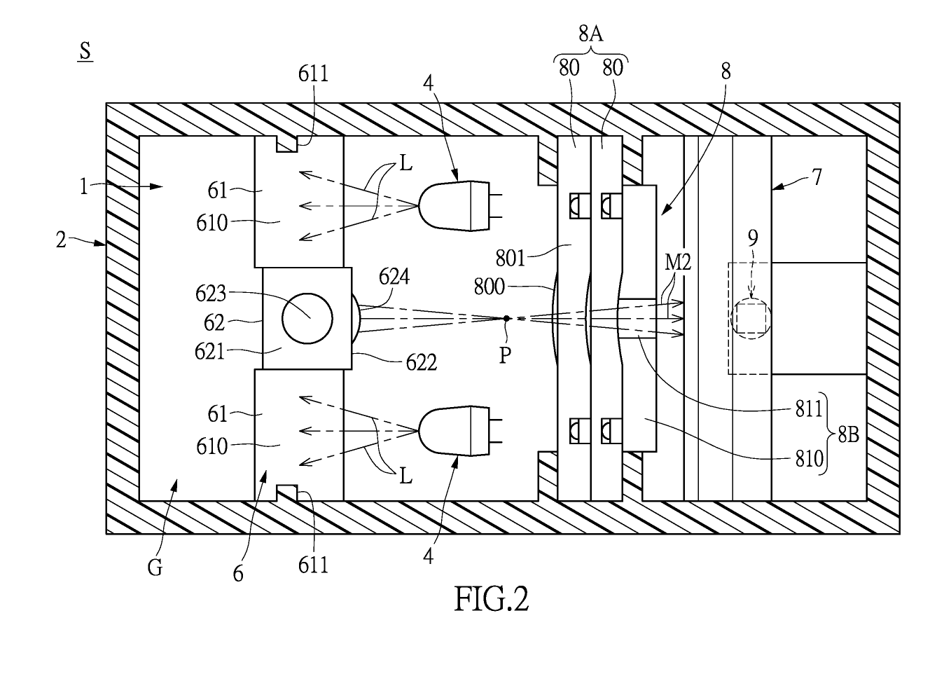

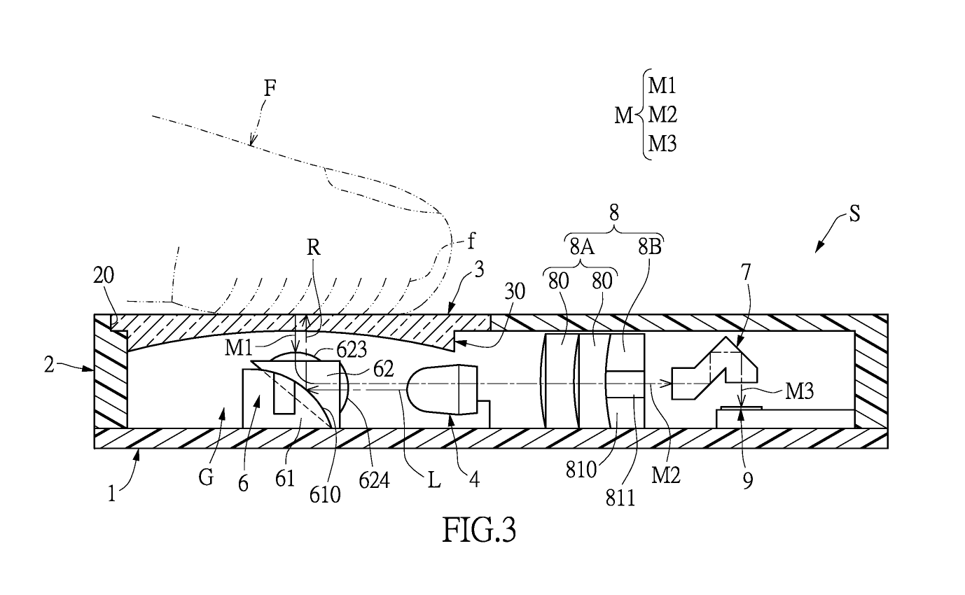

Referring to FIG. 1 to FIG. 3, FIG. 2 shows a cross-sectional view taken along the section line A-A of FIG. 1, and FIG. 3 shows a cross-sectional view taken along the section line B-B of FIG. 1. The first embodiment of the instant disclosure provides a fingerprint image capturing device S, comprising: a circuit substrate 1, an external casing 2, a light-transmitting element 3 and a fingerprint image capturing module G, and the fingerprint image capturing module G is disposed inside the external casing 2. The fingerprint image capturing module G includes at least one light-emitting element 4 (the first embodiment uses two light-emitting elements 4, but that is merely an example and is not meant to limit the instant disclosure), a first optical element 6, a second optical element 7, a lens assembly 8, and a fingerprint image sensing element 9.

Firstly, referring to FIG. 1 and FIG. 3, the external casing 2 is disposed on the circuit substrate 1, and the external casing 2 has a top opening 20 formed on the top side thereof. Because the size of the light-transmitting element 3 is substantially the same as the top opening 20, the light-transmitting element 3 can be disposed on the external casing 2 to enclose the top opening 20 of the external casing 2. For example, the light-transmitting element 3 has a lens portion 30 integrally connected to a bottom portion thereof, or an optical lens (not shown) is disposed between the light-transmitting element 3 and the first optical element 6, and both the light-transmitting element 3 and the first optical element 6 are separated from the optical lens (not shown) by a predetermined distance. The circuit substrate 1 may be a board having a predetermined circuit layout formed thereon in advance. The external casing 2 may be made of opaque material. The light-transmitting element 3 may be a transparent board made of glass or plastic material.

Moreover, referring to FIG. 2 and FIG. 3, the at least one light-emitting element 4 is electrically connected to the circuit substrate 1. More precisely, the at least one light-emitting element 4 (such as LED) is transversely placed on the circuit substrate 1, thus the projection light beam L generated by the at least one light-emitting element 4 is moved along a substantially transverse direction or substantially horizontal to the top surface of the circuit substrate 1.

In addition, referring to FIG. 2 and FIG. 3, the first optical element 6 is disposed beside one side of the at least one light-emitting element 4 and separated from the at least one light-emitting element 4 by a first predetermined distance, and the first optical element 6 has two light-reflecting structures 61 and a light-guiding structure 62 connected between the two light-reflecting structures 61. More particularly, each light-reflecting structure 61 has a light-reflecting curved surface 610 and a first positioning portion 611 positioned inside the external casing 2, and the light-guiding structure 62 has a first platform 621 facing the light-transmitting element 3, a second platform 622 facing the lens assembly 8 and vertical to the first platform 621, a first convex lens 623 disposed on the first platform 621, and a second convex lens 624 disposed on the second platform 622. Of course, the light-guiding structure 62 can be replaced by an optical fiber.

Furthermore, referring to FIG. 2 and FIG. 3, the second optical element 7 is disposed beside (next to) another side of the at least one light-emitting element 4 and separated from the at least one light-emitting element 4 by a second predetermined distance. The lens assembly 8 is disposed between the at least one light-emitting element 4 and the second optical element 7. The fingerprint image sensing element 9 is disposed under the second optical element 7 and electrically connected to the circuit substrate 1. More precisely, the second optical element 7 may be a substantial multistage prism that has at least three light-guiding surfaces, and light beams can be reflected via the at least three light-guiding surfaces by three times. The lens assembly 8 includes an optical lens 8A composed of at least one lens unit 80 (for example, there are two lens units 80 shown in FIG. 80) and an aperture stop 8B (or a pupil) adjacent to the optical lens 8A, each lens unit 80 has a lens portion 800 and a second positioning portion 801 connected to the lens portion 800 and positioned inside the external casing 2, and the aperture stop 8B has a screen portion 810 and a through hole 811 passing through the screen portion 810. The fingerprint image sensing element 9 may be any type of fingerprint image sensor according to different requirement or fingerprint image sensing chip.

Hence, referring to FIG. 2 and FIG. 3, a projection light beam L generated by the at least one light-emitting element 4 is directly projected onto the two light-reflecting structures 61, the projection light beam L is reflected by the light-reflecting curved surface 610 of the two light-reflecting structures 61 to form an illumination light beam R that first passes through the light-transmitting element 3 and then is upwardly projected onto a fingerprint f of a finger F. The illumination light beam R is formed as a wide-angle illumination that can be widely projected onto the fingerprint f of the finger F due to design of the two light-reflecting structures 61 of the first optical element 6, thus most of area of the fingerprint f of the finger F can be illuminated by the illumination light beam R. The illumination light beam R is reflected by the finger F to form an image light beam M that is downwardly projected onto the light-guiding structure 62 and then is guided by the light-guiding structure 62. The image light beam M first passes through the lens assembly 8 and then is downwardly projected onto the fingerprint image sensing element 9 through the second optical element 7 (i.e., the image light beam M is downwardly projected onto the fingerprint image sensing element 9 after the image light beam M passes through the lens assembly 8). Whereby, the fingerprint image sensing element 9 can receive the image light beam M to obtain a fingerprint image of the fingerprint f of the finger F that is touching the light-transmitting element 3.

More precisely, referring to FIG. 2 and FIG. 3, the illumination light beam R is reflected by the finger F to form a first fingerprint image light beam M1 that first passes through the light-transmitting element 3 and then is projected on the light-guiding structure 62 and is guided by the light-guiding structure 62 (as shown in FIG. 3). The first fingerprint image light beam M1 passes through the first convex lens 623 and enters into the light-guiding structure 62, and the first fingerprint image light beam M1 passes through the second convex lens 624 and leaves the light-guiding structure 62. The first fingerprint image light beam M1 passes through the lens assembly 8 to form a second fingerprint image light beam M3 that is projected onto the second optical element 7 (as shown in FIG. 2 or FIG. 3). The second fingerprint image light beam M2 is reflected by the second optical element 7 to form a third fingerprint image light beam M3 that is downwardly projected onto the fingerprint image sensing element 9 (as shown in FIG. 3). Whereby, the fingerprint image sensing element 9 can receive the third fingerprint image light beam M3 to obtain the fingerprint image of the fingerprint f of the finger F that is touching the light-transmitting element 3. It is worth noting that, both the first fingerprint image light beam M1 and the third fingerprint image light beam M3 are substantially vertical moving light beams that can be moved along a substantially vertical direction, and the second fingerprint image light beam M2 is a substantially horizontal moving light beam that can be moved along a substantially horizontal direction.

It is worth mentioning that the second convex lens 624 of the light-guiding structure 62 may be an optical objective lens, the lens portion 800 of the lens assembly 8 may be an optical eyepiece, the second fingerprint image light beam M1 is focused on a focus point P between the second convex lens 624 and the lens portion 800 and is projected onto the second optical element 7 to form an illumination area, and the illumination area can be enlarged by matching the optical objective lens (i.e., the second convex lens 624) and the optical eyepiece (i.e., the lens portion 800) so as to increase definition of the fingerprint image of the fingerprint f of the finger F captured by the fingerprint image sensing element 9.

In conclusion, the fingerprint image capturing device S can be miniaturized due to the arrangement of the at least one light-emitting element 4, the first optical element 6, the second optical element 7, the lens assembly 8, and the fingerprint image sensing element 9, thus the miniaturized fingerprint image capturing device S can be applied to any miniaturization electronic product such as cell phone.

### Second Embodiment

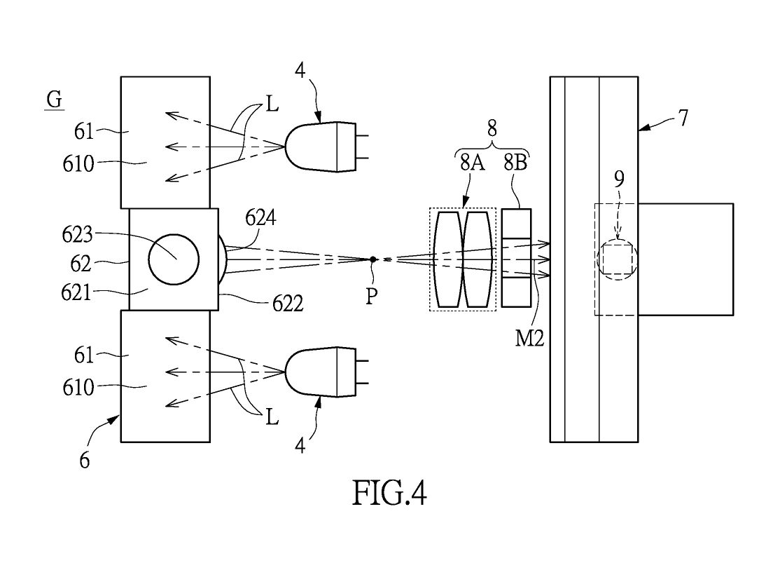

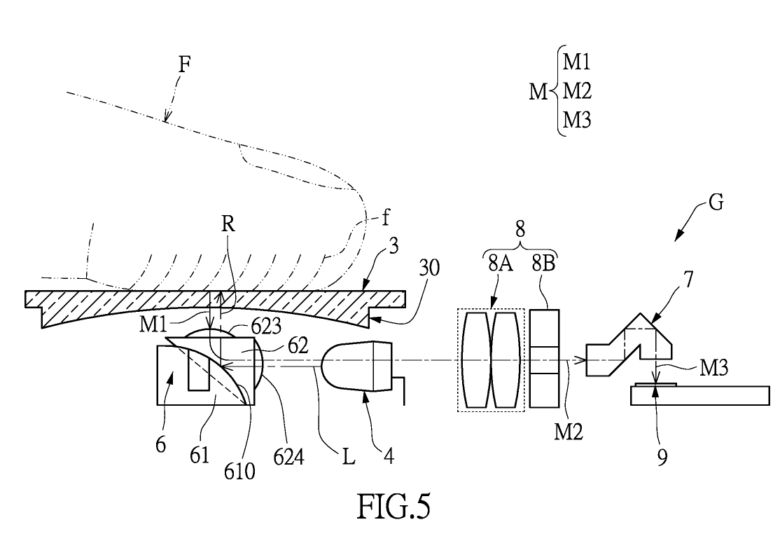

Referring to FIG. 4 and FIG. 5, the second embodiment of the instant disclosure provides a fingerprint image capturing module G, comprising: at least one light-emitting element 4 (the second embodiment uses two light-emitting elements 4, but that is merely an example and is not meant to limit the instant disclosure), a first optical element 6, a second optical element 7, a lens assembly 8, and a fingerprint image sensing element 9.

More particularly, the first optical element 6 is disposed beside one side of the at least one light-emitting element 4 and separated from the at least one light-emitting element 4 by a first predetermined distance, and the first optical element 6 has two light-reflecting structures 61 and a light-guiding structure 62 connected between the two light-reflecting structures 61. Each light-reflecting structure 61 has a light-reflecting curved surface 610, and the light-guiding structure 62 has a first platform 621 facing the light-transmitting element 3, a second platform 622 facing the lens assembly 8 and vertical to the first platform 621, a first convex lens 623 disposed on the first platform 621, and a second convex lens 624 disposed on the second platform 622. Of course, the light-guiding structure 62 can be replaced by an optical fiber. The second optical element 7 is disposed beside (next to) another side of the at least one light-emitting element 4 and separated from the at least one light-emitting element 4 by a second predetermined distance. The lens assembly 8 is disposed between the at least one light-emitting element 4 and the second optical element 7. The lens assembly 8 includes an optical lens 8A and an aperture stop 8B (or a pupil) adjacent to the optical lens 8A. The fingerprint image sensing element 9 is disposed under the second optical element 7.

Hence, referring to FIG. 4 and FIG. 5, a projection light beam L generated by the at least one light-emitting element 4 is directly projected onto the two light-reflecting structures 61, the projection light beam L is reflected by the light-reflecting curved surface 610 of the two light-reflecting structures 61 to form an illumination light beam R that first passes through the light-transmitting element 3 and then is upwardly projected onto a fingerprint f of a finger F. The illumination light beam R is formed as a wide-angle illumination that can be widely projected onto the fingerprint f of the finger F due to design of the two light-reflecting structures 61 of the first optical element 6, thus most of area of the fingerprint f of the finger F can be illuminated by the illumination light beam R. The illumination light beam R is reflected by the finger F to form an image light beam M that is downwardly projected onto the light-guiding structure 62 and then is guided by the light-guiding structure 62. The image light beam M first passes through the lens assembly 8 and then is downwardly projected onto the fingerprint image sensing element 9 through the second optical element 7 (i.e., the image light beam M is downwardly projected onto the fingerprint image sensing element 9 after the image light beam M passes through the lens assembly 8). Whereby, the fingerprint image sensing element 9 can receive the image light beam M to obtain a fingerprint image of the fingerprint f of the finger F that is touching the light-transmitting element 3.

More precisely, referring to FIG. 4 and FIG. 5, the illumination light beam R is reflected by the finger F to form a first fingerprint image light beam M1 that first passes through the light-transmitting element 3 and then is projected on the light-guiding structure 62 and is guided by the light-guiding structure 62 (as shown in FIG. 5). The first fingerprint image light beam M1 passes through the first convex lens 623 and enters into the light-guiding structure 62, and the first fingerprint image light beam M1 passes through the second convex lens 624 and leaves the light-guiding structure 62. The first fingerprint image light beam M1 passes through the lens assembly 8 to form a second fingerprint image light beam M3 that is projected onto the second optical element 7 (as shown in FIG. 4 or FIG. 5). The second fingerprint image light beam M2 is reflected by the second optical element 7 to form a third fingerprint image light beam M3 that is downwardly projected onto the fingerprint image sensing element 9 (as shown in FIG. 5). Whereby, the fingerprint image sensing element 9 can receive the third fingerprint image light beam M3 to obtain the fingerprint image of the fingerprint f of the finger F that is touching the light-transmitting element 3. It is worth noting that, both the first fingerprint image light beam M1 and the third fingerprint image light beam M3 are substantially vertical moving light beams that can be moved along a substantially vertical direction, and the second fingerprint image light beam M2 is a substantially horizontal moving light beam that can be moved along a substantially horizontal direction.

It is worth mentioning that the second convex lens 624 of the light-guiding structure 62 may be an optical objective lens, the lens portion 800 of the lens assembly 8 may be an optical eyepiece, the second fingerprint image light beam M1 is focused on a focus point P between the second convex lens 624 and the lens portion 800 and is projected onto the second optical element 7 to form an illumination area, and the illumination area can be enlarged by matching the optical objective lens (i.e., the second convex lens 624) and the optical eyepiece (i.e., the lens portion 800) so as to increase definition of the fingerprint image of the fingerprint f of the finger F captured by the fingerprint image sensing element 9.

In conclusion, the fingerprint image capturing device S can be miniaturized due to the arrangement of the at least one light-emitting element 4, the first optical element 6, the second optical element 7, the lens assembly 8, and the fingerprint image sensing element 9, thus the miniaturized fingerprint image capturing device S can be applied to any miniaturization electronic product such as cell phone.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. A fingerprint image capturing device, comprising:
a circuit substrate;
an external casing disposed on the circuit substrate, wherein the external casing has a top opening formed on the top side thereof;
a light-transmitting element disposed on the external casing to enclose the top opening of the external casing; and
a fingerprint image capturing module disposed inside the external casing, wherein the fingerprint image capturing module includes:
at least one light-emitting element electrically connected to the circuit substrate;
a first optical element disposed beside one side of the at least one light-emitting element and separated from the at least one light-emitting element by a first predetermined distance, wherein the first optical element has two light-reflecting structures and a light-guiding structure connected between the two light-reflecting structures;
a second optical element disposed beside another side of the at least one light-emitting element and separated from the at least one light-emitting element by a second predetermined distance;
a lens assembly disposed between the at least one light-emitting element and the second optical element; and
a fingerprint image sensing element disposed under the second optical element and electrically connected to the circuit substrate;
wherein a projection light beam generated by the at least one light-emitting element is directly projected onto the two light-reflecting structures, the projection light beam is reflected by the two light-reflecting structures to form an illumination light beam that first passes through the light-transmitting element and then is projected onto a fingerprint of a finger;
wherein the illumination light beam is reflected by the finger to form an image light beam that is projected onto the light-guiding structure and then is guided by the light-guiding structure, the image light beam first passes through the lens assembly and then is projected onto the fingerprint image sensing element through the second optical element, and the fingerprint image sensing element receives the image light beam to obtain a fingerprint image of the fingerprint of the finger.

2. The fingerprint image capturing device of claim 1, wherein each light-reflecting structure has a light-reflecting curved surface and a first positioning portion positioned inside the external casing, and the light-guiding structure has a first platform facing the light-transmitting element, a second platform facing the lens assembly and vertical to the first platform, a first convex lens disposed on the first platform, and a second convex lens disposed on the second platform, wherein the lens assembly includes an optical lens composed of at least two lens units and an aperture stop adjacent to the optical lens, each lens unit has a lens portion and a second positioning portion connected to the lens portion and positioned inside the external casing, and the aperture stop has a screen portion and a through hole passing through the screen portion, wherein the light-transmitting element has a lens portion connected to a bottom portion thereof.

3. The fingerprint image capturing device of claim 2, wherein the illumination light beam is reflected by the finger to form a first fingerprint image light beam that first passes through the light-transmitting element and then is projected on the light-guiding structure and is guided by the light-guiding structure, the first fingerprint image light beam passes through the lens assembly to form a second fingerprint image light beam that is projected onto the second optical element, the second fingerprint image light beam is reflected by the second optical element to form a third fingerprint image light beam that is projected onto the fingerprint image sensing element, and the fingerprint image sensing element receives the third fingerprint image light beam to obtain the fingerprint image of the fingerprint of the finger, wherein the first fingerprint image light beam passes through the first convex lens and enters into the light-guiding structure, and the first fingerprint image light beam passes through the second convex lens and leaves the light-guiding structure, wherein an optical lens is disposed between the light-transmitting element and the first optical element, and both the light-transmitting element and the first optical element are separated from the optical lens.

4. The fingerprint image capturing device of claim 3, wherein the second convex lens of the light-guiding structure is an optical objective lens, the lens portion of the lens assembly is an optical eyepiece, the second fingerprint image light beam is projected onto the second optical element to form an illumination area, the illumination area is enlarged by matching the optical objective lens and the optical eyepiece so as to increase definition of the fingerprint image of the fingerprint of the finger captured by the fingerprint image sensing element.

5. A fingerprint image capturing module, comprising:
at least one light-emitting element;
a first optical element disposed beside one side of the at least one light-emitting element and separated from the at least one light-emitting element by a first predetermined distance, wherein the first optical element has two light-reflecting structures and a light-guiding structure connected between the two light-reflecting structures;
a second optical element disposed beside another side of the at least one light-emitting element and separated from the at least one light-emitting element by a second predetermined distance;
a lens assembly disposed between the at least one light-emitting element and the second optical element; and
a fingerprint image sensing element disposed under the second optical element;
wherein a projection light beam generated by the at least one light-emitting element is directly projected onto the two light-reflecting structures, the projection light beam is reflected by the two light-reflecting structures to form an illumination light beam that first passes through a light-transmitting element and then is projected onto a fingerprint of a finger;
wherein the illumination light beam is reflected by the finger to form an image light beam that is projected onto the light-guiding structure and then is guided by the light-guiding structure, the image light beam first passes through the lens assembly and then is projected onto the fingerprint image sensing element through the second optical element, and the fingerprint image sensing element receives the image light beam to obtain a fingerprint image of the fingerprint of the finger.

6. The fingerprint image capturing module of claim 5, wherein each light-reflecting structure has a light-reflecting curved surface, and the light-guiding structure has a first platform facing the light-transmitting element, a second platform facing the lens assembly and vertical to the first platform, a first convex lens disposed on the first platform, and a second convex lens disposed on the second platform, wherein the lens assembly includes an optical lens composed of at least two lens units and an aperture stop adjacent to the optical lens, each lens unit has a lens portion and a second positioning portion connected to the lens portion, and the aperture stop has a screen portion and a through hole passing through the screen portion, wherein the light-transmitting element has a lens portion connected to a bottom portion thereof.

7. The fingerprint image capturing module of claim 6, wherein the illumination light beam is reflected by the finger to form a first fingerprint image light beam that first passes through the light-transmitting element and then is projected on the light-guiding structure and is guided by the light-guiding structure, the first fingerprint image light beam passes through the lens assembly to form a second fingerprint image light beam that is projected onto the second optical element, the second fingerprint image light beam is reflected by the second optical element to form a third fingerprint image light beam that is projected onto the fingerprint image sensing element, and the fingerprint image sensing element receives the third fingerprint image light beam to obtain the fingerprint image of the fingerprint of the finger, wherein the first fingerprint image light beam passes through the first convex lens and enters into the light-guiding structure, and the first fingerprint image light beam passes through the second convex lens and leaves the light-guiding structure, wherein an optical lens is disposed between the light-transmitting element and the first optical element, and both the light-transmitting element and the first optical element are separated from the optical lens, wherein the second convex lens of the light-guiding structure is an optical objective lens, the lens portion of the lens assembly is an optical eyepiece, the second fingerprint image light beam is projected onto the second optical element to form an illumination area, the illumination area is enlarged by matching the optical objective lens and the optical eyepiece so as to increase definition of the fingerprint image of the fingerprint of the finger captured by the fingerprint image sensing element.

8. A fingerprint image capturing module comprising at least one light-emitting element, a first optical element having two light-reflecting structures and a light-guiding structure, a second optical element, a lens assembly, and a fingerprint image sensing element, characterized in that:
a projection light beam generated by the at least one light-emitting element is directly projected onto the two light-reflecting structures, the projection light beam is reflected by the two light-reflecting structures to form an illumination light beam that first passes through a light-transmitting element and then is projected onto a fingerprint of a finger;
wherein the illumination light beam is reflected by the finger to form an image light beam that is projected onto the light-guiding structure and then is guided by the light-guiding structure, the image light beam first passes through the lens assembly and then is projected onto the fingerprint image sensing element through the second optical element, and the fingerprint image sensing element receives the image light beam to obtain a fingerprint image of the fingerprint of the finger.
a projection light beam generated by the at least one light-emitting element is reflected by the at least one light-emitting element and a light-reflecting curved surface of the first optical element in sequence to form an illumination light beam that first passes through a light-transmitting element and then is projected onto a fingerprint of a finger, the illumination light beam is reflected by the finger to form an image light beam that is projected onto the light-reflecting curved surface and then is reflected by the light-reflecting curved surface, the image light beam first sequentially passes through the at least one light-emitting element and the lens assembly and then is projected onto the fingerprint image sensing element through the second optical element, and the fingerprint image sensing element receives the image light beam to obtain a fingerprint image of the fingerprint of the finger.

9. The fingerprint image capturing module of claim 8, wherein each light-reflecting structure has a light-reflecting curved surface, and the light-guiding structure has a first platform facing the light-transmitting element, a second platform facing the lens assembly and vertical to the first platform, a first convex lens disposed on the first platform, and a second convex lens disposed on the second platform, wherein the lens assembly includes an optical lens composed of at least two lens units and an aperture stop adjacent to the optical lens, each lens unit has a lens portion and a second positioning portion connected to the lens portion, and the aperture stop has a screen portion and a through hole passing through the screen portion, wherein the light-transmitting element has a lens portion connected to a bottom portion thereof.

10. The fingerprint image capturing module of claim 9, wherein the illumination light beam is reflected by the finger to form a first fingerprint image light beam that first passes through the light-transmitting element and then is projected on the light-guiding structure and is guided by the light-guiding structure, the first fingerprint image light beam passes through the lens assembly to form a second fingerprint image light beam that is projected onto the second optical element, the second fingerprint image light beam is reflected by the second optical element to form a third fingerprint image light beam that is projected onto the fingerprint image sensing element, and the fingerprint image sensing element receives the third fingerprint image light beam to obtain the fingerprint image of the fingerprint of the finger, wherein the first fingerprint image light beam passes through the first convex lens and enters into the light-guiding structure, and the first fingerprint image light beam passes through the second convex lens and leaves the light-guiding structure, wherein an optical lens is disposed between the light-transmitting element and the first optical element, and both the light-transmitting element and the first optical element are separated from the optical lens, wherein the second convex lens of the light-guiding structure is an optical objective lens, the lens portion of the lens assembly is an optical eyepiece, the second fingerprint image light beam is projected onto the second optical element to form an illumination area, the illumination area is enlarged by matching the optical objective lens and the optical eyepiece so as to increase definition of the fingerprint image of the fingerprint of the finger captured by the fingerprint image sensing element.
